(19) United States
(12) Patent Application Publication
(10) Pub. No.: US 2010/0296143 A1
(43) Pub. Date: Nov. 25, 2010

(54) Lighting Unit for a Holographic Reconstruction System

(75) Inventors: Stephan Reichelt, Dresden (DE); Norbert Leister, Dresden (DE); Hagen Sahm, Dresden (DE)

Correspondence Address: Saul Ewing LLP (Philadelphia);Attn: Patent Docket Clerk, Penn National Insurance Plaza, 2 North Second St., 7th Floor, Harrisburg, PA, 17101, US

(73) Assignee: SEEREAL TECHNOLOGIES S.A., MUNSBACH (LU)

(21) Appl. No.: 12/863,782

(22) PCT Filed: Jan. 19, 2009
(86) PCT No.: PCT/EP09/50556

§ 371 Date: Jul. 21, 2010

(30) Foreign Application Priority Data
Jan. 21, 2008 (DE) 10 2008 000 116.3

(51) Int. Cl. G03H 1/22

(52) U.S. Cl. 359/32

(57) ABSTRACT

An apparatus for the reconstruction of computer-generated video holograms has the object of reconstructing bandwidth-limited holograms with high luminance and image quality in a display having low installation depth, low weight, and reduced effort during production. The apparatus has a focal center field having diffractive optical elements, which conduct coherent light after modulation by a light modulator matrix, which is coded using a video hologram, to an eye position, wherein said light reconstructs a three-dimensional scene in the space spanned by the viewing window and said light modulator.

The present invention relates to an illumination unit for a holographic reconstruction system which holographically reconstructs a three-dimensional scene. The reconstruction system comprises among other components light modulator means and an illumination unit. Illumination means in the illumination unit emit coherent light which coherently illuminates the surface of the light modulator means through optical focussing means. To achieve the reconstruction, a signal processor computes for example based on the image information and depth information of a scene at least one video hologram and encodes the latter on a modulator cell structure of spatial light modulator means. If the light modulator means are illuminated with coherent light then a modulated wave front is created which holographically reconstructs a three-dimensional scene in front of the eyes of at least one observer.

Light modulators with a resolution of at least several millions of pixels, as they are used in conventional image display means or projectors for video and TV presentations, are for example particularly suited as light modulator means. A desired three-dimensional scene can only be reconstructed sufficiently with this relatively low resolution if as many pixels of the light modulator as possible only reconstruct those object light points of the scene which are visible from an eye position of observer eyes in a confined viewing space. To achieve this, in contrast to conventional holograms, the signal processor preferably only encodes a spatially confined sub-hologram on the modulation surface of the light modulator means with hologram information for each object light point. This has the advantage that the system only reconstructs such light points which can be perceived in the visibility region from the perspective of an eye position.

The present invention relates in particular to the optical focussing means in the illumination unit for illuminating the surface of the light modulator means with at least one coherent light wave front for a holographic reconstruction system of said type.

In several patent applications, for example in the international publication no. WO 2004/044659, titled “Video hologram and device for reconstructing video holograms”, the applicant of this invention has already disclosed a holographic reconstruction system in which the illumination unit according to the present invention can preferably be applied.

The publication no. WO 2004/044659 discloses a reconstruction system which comprises an illumination unit with illumination means and focussing means, and light modulator means. A focussing field lens serves as the focussing means in that reconstruction system. With a modulator resolution of a conventional liquid crystal display, which is rather low for video holograms, the system allows a holographically reconstructed scene to be made visible in a reconstruction space which stretches between the spatial light modulator and a visibility region at an eye position in a large viewing angle and with great spatial depth at good resolution for at least one observer. The light modulator means modulate the focussed light wave with the above-described code, where the hologram information for each object light point is only carried by a confined modulation surface in the form of a sub-hologram. The visibility region is generated as the result of Fourier transformations of the sub-holograms which are superposed in the focal point of the light wave which propagates towards an eye position. The focussing means realise the necessary Fourier transformation optically in this arrangement. During computation, the sub-holograms are reduced to a sub-region of the entire modulation surface such that the visibility region lies within one diffraction order which is created due to the grid structure of the light modulator means with its multiple modulator cells.

It is disadvantageous though that the required effective width of the focussing field lens must correspond with the dimensions of the light modulator means. This makes the appliance very bulky, as well as material-consuming and costly.

In the older international publication WO 2006/119920, titled “Device for holographic reconstruction of three-dimensional scenes”, the applicant also discloses a device which also uses at least one visibility region which is smaller than the surface of the light modulator at an eye position for watching the reconstructed scene. That device also encodes a sub-hologram for each visible object light point.

Instead of a single light source, that device comprises an array of light sources with illumination elements which are capable of generating interference but which are not mutually coherent, where each illumination element is assigned with a separate focussing element. The focussing elements are disposed together in a focussing matrix in the form of an array of focussing lenses. Together with the corresponding focussing element in the focussing matrix, each illumination element of the array of light sources works like an elementary illumination unit which only illuminates a sub-region of the surface of the light modulator with a separate partial wave. Each focussing element images its assigned illumination element at the eye position. The illumination elements are preferably point light sources each of which emitting a spherical wave.

The size, form and location of the sub-holograms are not identical with the size, form and location of the sub-regions on the surface of the light modulator which are illuminated by the elementary illumination units. The size and location of the sub-holograms is defined mainly by the position and technically realisable size of the visibility region in conjunction with the axial and lateral position of the object light point which is to be reconstructed. The geometrical structure of the focussing matrix can be chosen according to other technical parameters, such as the number of illumination elements which are necessary in order to achieve a desired light density, the desired focal lengths of the focussing means, and other parameters.

A major advantage of the prior art device is that each of the illumination elements in the array of light sources which are capable of generating interference illuminates a different region of the light modulator, so that the partial light waves which are thereby generated do not have to exhibit mutual coherence.

However, a holographic reconstruction with a sufficiently high resolution can only be realised with a relatively low resolution of the light modulator if the size of the visibility region is reduced about to the size of an eye pupil. In order to be able to use the reconstruction system comfortably, the system must comprise a position detection and tracking system which matches the position of the visibility region with the actual eye position of an observer, i.e. to track it accordingly.

In one physical form of that illumination unit, this may be realised in that the illumination elements are displaced laterally, i.e. at right angles to the optical axis of the system, in relation to the focussing matrix. The separate waves which are emitted by the elementary illumination units therefore pass through their corresponding focussing element at different angles of propagation, which depend on the actual eye position. The same problem also occurs in a system which takes advantage of a field lens for focussing.

In the prior art reconstruction systems, the focussing means realises a number of functions, such as a collimation of the coherent light to form a homogeneous light wave, an imaging of the light sources at an eye position, and an optical transformation of the light wave modulated by the light modulator to the eye position, whereby the visibility region which has been described above is generated at the eye position. The focussing means of the prior art reconstruction systems use optical components for this which work on the principle of refraction and/or reflection of the light. This is why such focussing means comprise refractive or reflective elements such as lenses, prisms, mirrors or deflecting prisms.

This has the disadvantage that an illumination unit with refractive components in the focussing means accounts for a substantial share of the total volume of a holographic reconstruction system, so that such a display device has a very bulky design.

Another disadvantage of refractive components is that they may effect substantial monochromatic aberrations (e.g. spherical aberrations) which are dependent on the numerical aperture and the angles of propagation. If the modulated wave which originates in the illumination unit is disturbed by aberrations, this may bring about errors in the coincidence of the visibility regions of different partial waves. This means that the visibility regions of different partial waves of the illumination devices are not correctly matched at the eye position.

Further, the aberrations cause reconstructed points to not appear at the desired position, so that the entire geometrical optical appearance of the reconstructed scene is biased.

In the extreme case, the positions of reconstructed light points can be so far away from the desired positions that individual reconstructed light points can no longer be perceived by the observer eye in the visibility region.

In order to reconstruct a scene in colour, video holograms are for example illuminated with coherent light of different wavelengths, for example with light waves of the primary colours red, green and blue. As is generally known, refractive components exhibit a dependence of the refractive index on the light wavelength during the passage through the medium of the optical components. This so-called dispersion effects chromatic aberrations (chromatic shifts of the focal point) during the reconstruction of colour scenes, which can be perceived as disturbing colour linings when watching the reconstruction from the visibility region.

In addition to an illumination of light modulator means with refractive optical means, an illumination with diffractive optical elements has been described in the prior art. For example, U.S. Pat. No. 6,002,520, titled ‘Illumination system for creating a desired irradiance profile using diffractive optical elements’, discloses an illumination system which provides with the help of a single light source a desired irradiance profile for a region of a surface. The system takes advantage of an optical imaging system for imaging the light source at the surface, and an array of diffractive optical elements (DOE) for generating the desired irradiance profile.

In order to illuminate the entire surface, this illumination unit also requires a great deal of optical components and has a large extent in the direction of the optical axis of the system and thus a large volume. It is therefore not really suitable for the desired application when keeping in mind the demands made on a compact holographic reconstruction system.

In the context of the present invention, a diffractive optical element (DOE) is a transmissive or reflective substrate which carries a periodic microstructure which shapes the coherent light of a propagating wave using the effect of light diffraction. Due to different wavelengths in the propagating light wave, local phase modulations are created at the periodic microstructures as light waves propagate, thus generating an interference pattern. If the microstructure of a diffractive optical element is designed accordingly, constructive or destructive interference makes it possible to specifically define the propagation of a coherent wave. Diffraction at the two-dimensional periodic microstructures of a diffractive optical element with periods in the range of some micrometres and/or in the range of the light wavelength causes the light waves to be deflected in different diffraction orders, for example with binary diffractive microstructures. This means that the exiting light waves have a complex light distribution. Selecting a corresponding periodic microstructure, such as a structure of micro-prisms, a so-called blaze grating, specifically affects the propagating waves. Undesired diffraction orders which cause disturbing stray light in the system and which thus reduce the efficiency of the system can thus be suppressed.

Further, U.S. Pat. No. 5,589,982, titled ‘Polychromatic diffractive lens’, discloses a diffractive lens for multi-spectral illumination which can be used for example for an RGB colour display device with light with different spectral light components. The lens comprises a diffractive microstructure in the form of a Fresnel zone structure. The microstructure comprises a multitude of zones which direct the light components of different light wavelengths at a single common focal point in a space. The structure shifts in a position depending way the phase of the light wave which falls on the lens and diffracts the light of each spectral light component on its way to the focal point in different diffraction orders.

It is therefore the object of the present invention to provide for a holographic reconstruction system a highly efficient illumination unit for illuminating the light modulator means, which ensures an extremely low structural depth of the holographic reconstruction system in an inexpensive way and with only little cost of materials, thereby circumventing the disadvantages of diffractive lens arrays pointed out above.

The present invention is based on a holographic reconstruction system for the three-dimensional reconstruction of object light points of a scene, comprising spatial light modulator means which modulate with at least one video hologram at least one light wave which is capable of generating interference and which is emitted by illumination means. Optical focussing means focus the modulated light wave which comprises holographically reconstructed object light points on at least one eye position of observer eyes. The system encodes the light modulator means such that the light wave reconstructs the object light points in front of the eye position irrespective of the directing and tracking of the light wave.

The reconstruction system comprises at least one array of optical focussing means, which has focussing elements which are arranged in a matrix, and an array of light sources, which has illumination elements which are arranged in a matrix and which emit light which is capable of generating interference. The focussing elements are arranged in the array of focussing means such that each focussing element is assigned with at least one illumination element of the array of light sources. The reconstruction system can comprise a single array of focussing means or multiple focussing means and/or multiple arrays of focussing means which are arranged one after another in the optical path, for example in order to realise a multi-stage imaging process.

According to the present invention, the array of focussing means is a matrix arrangement of diffractive optical elements (DOE) on a transmissive or reflective substrate, each of which being assigned to an illumination element of the array of light sources, in order to shape the coherent light of the corresponding illumination element to form a partial light wave which is capable of generating interference.

The diffractive optical elements image the corresponding light sources really or virtually or direct their corresponding partial light waves such that a specifiable illumination wave, which is composed of the individual partial light waves, illuminates the spatial light modulator means. The composed illumination wave is preferably plane, spherical or cylindrical.

If the reconstruction system only has one array of focussing means, the light sources are imaged in a single-stage process at the vicinity of the eye positions of the observer, i.e. all partial light waves are directed such that they coincide in a common focal point at the eye position after having illuminated a sub-region of the surface of the modulator means. In this case, each diffractive optical element of the array of focussing means images its corresponding illumination element of the array of light sources at the eye position.

Alternatively, the reconstruction system can comprise multiple focussing means and/or multiple arrays of focussing means which are arranged one after another in the optical path in order to realise a multi-stage imaging of the array of light sources at the eye position of the observer. For example, in a first stage of the imaging process, all light sources can be imaged at infinity such that the individual partial light waves compose a plane illumination wave for the spatial light modulator means. In this case, the imaging of the light sources at the eye position of the observer is realised in a second stage with the help of another focussing means or array of focussing means. It is also possible and preferable to distribute the refractive power of the focussing means which is required to image of the light sources at the eye position to the individual focussing means and arrays of focussing means used, e.g. in order to take into consideration certain manufacturing limits of the diffractive structures.

Array of focussing means and/or focussing means are preferably arranged closely in front of or behind the light modulator means of the reconstruction system. The array of focussing means thus illuminates the entire modulator cell surface of the light modulator means, and all modulator cells can be used to encode sub-holograms, thus generating a wide viewing angle for the observer.

The illumination elements are preferably point light sources or line light sources, each of which emitting a spherical wave or a cylindrical wave, respectively.

In a preferred embodiment, the diffractive optical elements are arranged in a plane and realise the optical function of a vaulted lens array. This can be realised in particular in that the pitch of the diffractive optical elements which are arranged in a matrix differs from the pitch of the matrix of illumination elements in the lateral direction, i.e. at right angles to the optical axis of the system.

In order to be able to direct the modulated light wave at at least one eye position and to track the focussed partial light waves to the actual eye position if the observer moves, optical deflection means can preferably be disposed downstream the optical focussing means and downstream the modulator means in the optical path of the modulated light waves which are capable of generating interference, said optical deflection means comprising at least one array with controllable deflection elements.

In contrast to prior art illumination units, according to the present invention the array of focussing means with diffractive optical elements (DOE) which are arranged in a matrix realises an illumination of the light modulator means with very little aberrations. Each diffractive optical element (DOE) of the array of focussing means creates a partial light wave, and the individual partial light waves are then combined to compose an ideal or at least near-ideal wave for illuminating the light modulator means. The composed illumination wave can preferably be plane, spherical or cylindrical, or have another defined shape. Further, each diffractive optical element images its corresponding illumination element at a common point in space at the desired eye position, if necessary in conjunction with further focussing means or arrays of focussing means. All diffractive optical elements of the array of focussing means realise—if necessary together with further focussing means or arrays of focussing means—the Fourier transformation which is required for the holographic reconstruction of the scene.

Since only an illumination with three discrete light wavelengths is necessary to realise a colour holographic reconstruction with all desired colours, another feature of the invention takes advantage of the dependence of the optical behaviour of the diffractive optical elements on the usage of discrete light wavelengths. According to this invention, for colour reconstructions the periodic microstructures in the array of focussing means are dimensioned for the operation with certain discrete spectral wavelengths, and they are designed such that in the waves of light components with different light wavelengths which are emitted by the illumination unit each light wavelength contributes through a separate diffraction order to the desired partial light wave. The periodic microstructures shift in a position depending way the phase of the light wave which falls on the diffractive optical elements and diffract the light of each spectral light component on its way to the focal point in different diffraction orders.

These diffraction orders are chosen such that the microstructures deflect the light of the selected discrete light component waves each into the same direction, while exhibiting a high diffraction efficiency of the selected discrete light wavelengths. Optionally in combination with further focussing means or arrays of focussing means, the light of the different spectral light components is directed at a common focal point in space.

This common point defines the necessary eye position for watching the reconstructed scene. In the reconstruction system which generates a visibility region by way of a Fourier transformation, the visibility region is created at that point. This specific embodiment of this invention circumvents both monochromatic aberrations and chromatic aberrations and simultaneously theoretically provides an almost 100-percent diffraction efficiency.

The diffractive optical elements of the focussing means can also comprise prism elements, so-called blaze gratings, which are adjusted precisely exclusively to the light wavelengths of the primary colours used. This way, only those light portions of the illumination elements which are in the desired diffraction orders reach the focal point, and light loss and disturbances in diffraction orders which cannot contribute to the reconstruction or which are not desired in the reconstruction are prevented or suppressed.

According to a further feature of the invention, the illumination unit according to this invention is used in a holographic reconstruction system which includes a system controller with position detection means and wave tracking means so to enable a focal point and the modulated light waves to be tracked in accordance with the actual eye position.

In order to match the position of the common focal point in space to the actual eye position, the array of focussing means and/or the focussing means have diffractive optical elements (DOE), where the diffraction properties of the periodic microstructures include discretely controllable micro-cells.

In order to direct the modulated focussed light waves prior to reconstructing the scene laterally at the actual eye position, the controllable micro-cells can realise controllable optical gratings with prism functions. This can for example be achieved with the help of arrangements of electrowetting cells with cell sizes of few micrometres and less. In conjunction with the electrowetting cells, reference is made to the hitherto unpublished international patent application PCT/EP2008/064052, just to serve as an example.

Diffractive optical elements are particularly suited for an illumination of light modulator means which require light which is capable of generating interference, such as holographic reconstruction systems, because coherent or at least partly coherent light is used. For colour reconstructions with discrete light wavelengths, diffractive optical elements which use different diffraction orders can be corrected quite well with relatively little effort.

Now, an exemplary description of the computation of a single diffractive optical element will be given. It is apparent for a person skilled in the art that an array of focussing means according to this invention can be made by laterally adjoining multiple diffractive optical elements, where the individual diffractive elements can realise identical or different phase functions.

The continuous phase function φ(x,y) of a diffractive optical element describes the phase difference between the desired exit wave and the incident wave, i.e. the phase difference of the wave before and after the diffractive optical element. DOEs have the advantage that almost any kind of wave front can be generated, so that an aberration correction can be achieved easily in that the desired ideal exit wave and the actually present incident wave are used for computation. In a further step, the so-called blaze procedure, the continuous phase function φ(x,y) is transformed into a modulo m 2π phase profile, which can be described by ψ(x,y)=φ(x,y)·mod(m 2π), where m is an integer number and represents the so-called ‘blaze order’. The blaze order m is an additional degree of design freedom, which can specifically be taken advantage of according to a further feature of the present invention. Differently blazed phase profiles ψ(x,y) can be created on the basis of one and the same phase function φ(x,y) in that higher blaze orders are used than the typically employed first blaze order. If blazing in a higher order is employed, multiple discrete wavelengths can be found for which the DOE realises the same desired wave front with identically high diffraction efficiency. This will be the case if the condition mλ₀=qλ_{blaze} is satisfied, where m is the blaze order for the design wavelength λ₀ and q is the blaze order for a different wavelength, the so-called blaze-matched wavelength λ_{blaze}. In order to find suitable orders for m and q at given discrete wavelengths, the lowest common multiple of these wavelengths is determined. This wavelength then represents the synthetic design wavelength of the diffractive optical element. In a last step of the design procedure, the blazed phase profile is transformed into a surface profile. Both the blaze order and the material of the microstructures must be taken into consideration when defining the depth of the microstructures. Blazing in a higher order has the additional advantage that microstructures are generated which are simpler to be manufactured.

Since only three light wavelengths are preferably required in a colour holographic reconstruction system according to the present invention, diffraction orders with a relatively low blaze order can be chosen, e.g. the fifth, sixth and seventh diffraction order. This simplifies the manufacture of the array of focussing means.

Since diffractive optical elements are known to allow both conventional optical functions (e.g. lenses, prisms) and free-form phase functions (e.g. aspherical elements) and novel beam forming properties to be realised, multiple optical parameters can be corrected better simultaneously. Thereby, focussing properties are achieved which cannot be realised with refractive means. The phase modulation of the wave which is diffracted at the DOE is preferably achieved by a surface microstructure on the DOE substrate. Alternatively, a phase modulation can be realised by way of refractive index modulation in the substrate or in a thin film which is applied on the substrate.

The diffractive optical elements described above realise diffraction efficiencies in a range of between 95 and 99 percent for the selected discrete wavelengths. The achievable diffraction efficiency is determined mainly on the tolerances of the manufacturing process for the structures with diffractive effect.

The present invention preferably allows an illumination unit for a holographic reconstruction system to be manufactured which ensures a very low structural depth of the entire device. The axial depth of the illumination unit can be reduced drastically because the realisable structural depth is determined only by a sensible compromise between the number of illumination elements in the array of light sources and the size of a single diffractive optical element.

To be able to reconstruct coloured three-dimensional scenes, it is essential that the illumination elements in the illumination devices have the form of point light sources or line light sources, which emit simultaneously or sequentially in one point of origin the three primary colours which are required for a colour reconstruction. Such colour point light sources can for example be realised as the ends of fibre bundles or waveguides.

The illumination elements can illuminate the focussing elements directly or through deflection means such as light waveguides.

A number of manufacturing technologies are known to make defined microstructures in or on surfaces with heights in the range of few micrometres and lateral dimensions in the range of several micrometres to several hundred micrometres, for example photolithographic methods or laser beam, electron beam or ion beam methods or single-grain diamond machining. Alternatively, the microstructures can be manufactured with the help of a master mould which is used in an inexpensive mass replication process, or in a direct photolithographic process without a master.

An embodiment of the present invention will be explained below with the help of an application and accompanying figures, where:

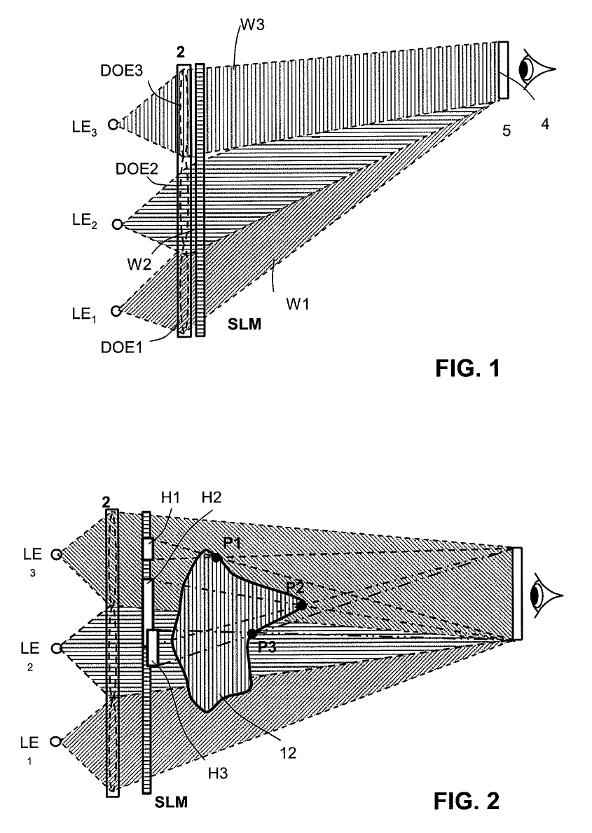

FIG. 1 shows the general layout of a holographic reconstruction system in which the illumination unit according to this invention is used. The general function of the reconstruction system has already been disclosed by the applicant in the international patent application no. WO 2006/119920, titled “Device for holographic reconstruction of three-dimensional scenes”. This drawing, only three exemplary illumination elements LE1 . . . LE3 of an array of light sources are shown in the illumination unit according to this invention, while it is in practice a two-dimensional array which comprises a matrix arrangement of illumination elements LE1 . . . LEn. Each illumination element LEm is assigned with a diffractive optical element DOE which serve as focussing elements DOE1 . . . DOE3 of an array of focussing means 2. The focussing elements DOE1 . . . DOE3 image the illumination elements LE1 . . . LE3 through the modulator cells (not shown) of a spatial light modulator SLM at a common focal point 4 or realise the first stage of a multi-stage imaging process in that they image the light sources into infinity, while they are imaged at a common focal point by a further focussing means (not shown). The focal point 4 simultaneously represents the eye position of the eye of an observer. During this imaging, the waves which are capable of generating interference illuminate sub-regions of the light modulator SLM on which the sub-holograms H1 . . . H3, which are shown exemplarily in FIG. 2, of object light points P1 . . . P3 of a scene to be reconstructed are encoded. A visibility region 5 is generated at the focal point 4 as a result of the Fourier transformation of the sub-holograms H1 . . . H3, which is realised by the focussing elements DOE1 . . . DOE3, if necessary in conjunction with a further focussing means, from the encoded light modulator regions through which the partial light waves W1 . . . W3 pass. The size of the visibility region 5 is defined by the size of the sub-holograms H1 . . . H3.

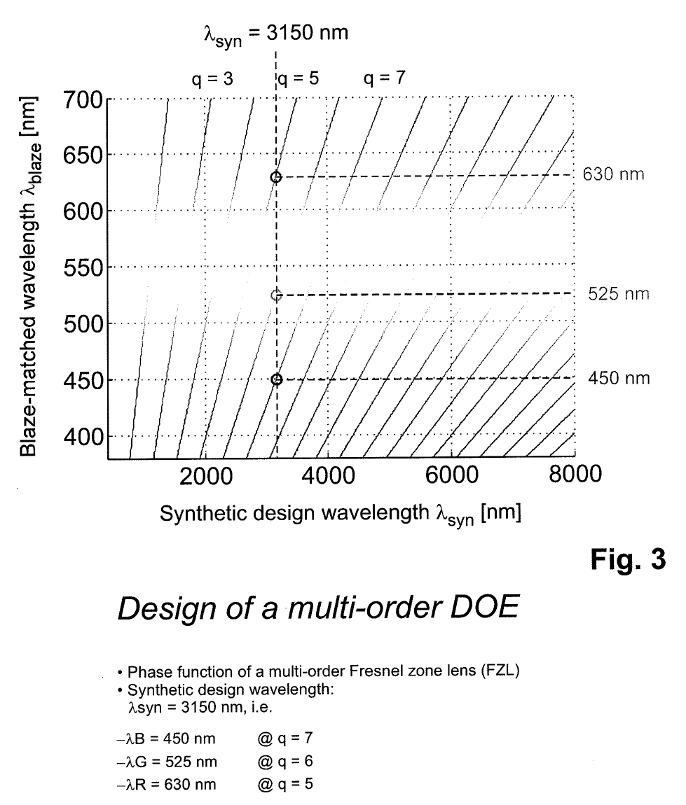

Referring to FIG. 3, the diagram shows a design of a single diffractive optical element for light with the wavelengths λ_{blue}=450 nm, λ_{green}=525 nm and λ_{red}=630 nm. The diagram shows that a common synthetic design wavelength for the microstructure of λ_{syn}=3150 nm can be chosen for red in the fifth diffraction order, for green in the sixth diffraction order, and for blue in the seventh diffraction order. It is apparent to a person skilled in the art that a different synthetic design wavelength can be chosen as well. This can be preferred if only light sources of other wavelengths are available at all or at more favourable costs, if more than three different wavelengths are to be used, or if a larger colour space is to be realised.

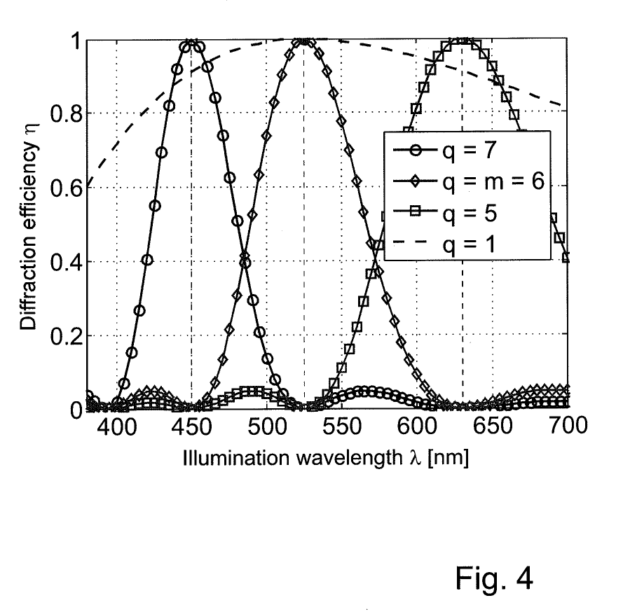

Referring to FIG. 4, the diagram shows the diffraction efficiency of an embodiment of a diffractive optical element which is used according to the present invention with blaze orders greater than one over the wavelength. It illustrates that theoretically a scalar diffraction efficiency of 100 percent can be achieved for the three discrete wavelengths (primary colours: blue=450 nm, green=525 nm and red=630 nm) at the respective blaze orders q, and that for other wavelengths, which do not correspond with the discretely selected colours, the diffraction efficiency is drastically reduced. In contrast, the broken line shows the behaviour of a conventional diffractive optical element whose the first blaze order is used, where the wavelength sensitivity as regards the illumination wavelength is clearly reduced. The diagram further illustrates that the diffraction efficiency is the more sensitive to small wavelength fluctuations the higher the selected blaze order. This means that for the three exemplarily chosen wavelengths the diffractive optical element behaves most sensitive to wavelength fluctuations in the spectral range of the blue light, because the ninth blaze order was selected for blue. In the spectral range of the red light, minor fluctuations do not have such strong effect on a reduced diffraction efficiency. It is thus preferable to use blaze orders which are as low as possible in order to restrict this effect to a minimum.

1. Illumination unit for spatial light modulator means of a holographic reconstruction system for the three-dimensional reconstruction of object light points of a scene, where the spatial light modulator means modulate light waves which are capable of generating interference and which are emitted by illumination means with at least one video hologram, where the illumination unit comprises an array of focussing means with focussing elements which are arranged in a matrix and which focus the modulated light waves with the reconstructed object light points to at least one eye position of observer eyes, and where the illumination unit further comprises an array of light sources which comprises illumination means which are arranged in a matrix and which emit light which is capable of generating interference, where the focussing elements are arranged in the array of focussing means such that each focussing element is assigned to at least one illumination element of the array of light sources, wherein the array of focussing means comprises a matrix arrangement of diffractive optical elements (DOE) on a transmissive or reflective substrate and that each diffractive element is assigned to an illumination element of the array of light sources in order to shape the coherent light of the assigned illumination element such to form a partial light wave which is capable of generating interference which propagates to an eye position, where the diffractive optical elements (DOE) focus their corresponding partial light waves or combine them to form an illumination wave of a predetermined shape, and where they illuminate the spatial light modulator means, and where they direct all partial light waves—if necessary in combination with further focussing means—such that they coincide essentially in a common focal point at the eye position after having illuminated sub-regions of the surface of the modulator means.

2. Illumination unit according to claim 1, where the diffractive optical elements are arranged in a plane and realise the optical function of a curved lens array.

3. Illumination unit according to claim 1, where the diffractive optical elements are arranged in a plane and realise the optical function of a plane lens array and direct all partial light waves with the help of at least one further focussing element which is disposed downstream in the optical path such that they coincide essentially in a common focal point at the eye position after having illuminated sub-regions of the surface of the modulator means.

4. Illumination unit according to claim 1 for a colour holographic reconstruction with video holograms which are illuminated with coherent light which comprises different discrete spectral wavelengths, where the diffractive optical elements (DOE) are designed such to achieve a multispectral light diffraction and use separate diffraction orders for the propagation of the waves for each spectral wavelength.

5. Illumination unit according to claim 4, which applies the wavelength-dependent optical behaviour of the diffractive optical elements such that when forming the light waves of the light components such a separate diffraction order is selected for each light wavelength where the microstructures of the diffractive optical elements (DOE) direct the light of each light component wave into substantially the same, specifiable direction, or where they direct it at a common focal point in space.

6. Illumination unit according to claim 4, which applies prism elements in the periodic microstructure which are arranged such that light of diffraction orders which do not direct the waves at the eye position are suppressed.

7. Illumination unit according to claim 1, which is used in a holographic reconstruction system which includes a system controller with position detection means and wave tracking means so to enable the focal point and the modulated light waves to be tracked in accordance with the actual eye position.

8. Illumination unit according to claim 7, which comprises an array of focussing means with diffractive optical elements (DOE) with periodic microstructures, where the diffraction properties of the periodic microstructures comprise discretely controllable micro-cells in order to change the focus values in dependence on the eye position.

9. Illumination unit according to claim 7, where the controllable micro-cells realise prism functions for a controllable optical grating in order to laterally direct the modulated and focussed light waves, which are directed at a near-axis basic position, at the actual eye position before the scene is reconstructed.

10. Illumination unit according to claim 1, where the controllable micro-cells are electrowetting cells with cross-sections of a multiple of the light wavelength, so that the propagation parameters of the light waves for illuminating the light modulator means can be changed through phase changes.
